(19) United States
(12) Patent Application Publication
(10) Pub. No.: US 2012/0294680 A1
(43) Pub. Date: Nov. 22, 2012

(54) Device and method for anchoring a cable bolt

(76) Inventors: Richard Stanton McClellan, Ontario (CA); Horst-Peter Simon, Buchholz (DE)

(21) Appl. No.: 13/110,209

(22) Filed: May 18, 2011

(51) Int. Cl. E21D 9/00; F16L 55/00; E21D 21/00

(52) U.S. Cl. 405/132; 405/302.4; 405/259.5; 285/119

(57) ABSTRACT

The invention provides a method for anchoring a cable bolt in a ground formation using a multi-part resin system and an injection adaptor for use in the anchoring method.

The present invention provides a device and method for anchoring a cable bolt in a ground formation.

A cable bolt is used in mining and in civil engineering to support soil or rock formations to secure a steep bank or a roof, wall or floor in a mine or tunnel. Typically, cable bolts are used to secure ground formations in challenging conditions such as where drilled holes will be oversized or where the formations will be fractured and/or washed out.

Cable bolts are usually anchored in place using a grout system which is cement-based or polymer-based. It is difficult to find a grout system which is pumpable for a sufficient time but then cures quickly enough and with a sufficiently strong early cure strength for the cable bolt to be effective without additional early support. Cement grouting of cable bolts is frequently plagued with quality assurance and quality control issues related to the grouting process. Cement grouting is a relatively complex procedure as it is necessary to install a breather tube and to block the hole opening with stemming material to prevent escape of uncured cement grout. Typically, when a cable bolt is used with a cement grout, it takes over 24 hours for the cement to cure before further work may be done in the area of the cable bolt.

As an alternative to a pumpable grout system, it is known to use resin cartridge anchoring. However even with standard rock bolts, resin cartridge anchoring is ineffective in the challenging conditions in which cable bolts are typically used. Cable bolts are less suited to use with resin cartridges because it is difficult to ensure that a cable bolt both pierces the resin cartridge and mixes its contents properly.

Accordingly, there is a need for a rapid cable bolt installation system without the usual long delays associated with cement grout curing. A way of ameliorating this need has been sought.

According to the invention there is provided an injection adaptor suitable for injecting a multi-component resin into a ground formation wherein the adapter comprises a resin component input port, a static mixer and a mixed resin output port.

According to the invention there is provided a system comprising a cable bolt, the injection adapter according to the invention and a multi-part resin system.

According to the invention there is also provided a cable bolt secured in a ground formation by a multi-part resin system.

According to the invention there is further provided a method of securing a cable bolt in a hole drilled in a ground formation which method comprises the steps of:
providing a cable bolt, an injection tube, and an injection adaptor according to the invention;
inserting the cable bolt and the injection tube into the drilled hole such that an end of the injection tube is arranged at or near the distal end of the drilled hole;
connecting the injection adaptor to the injection tube; and
pumping a multi-part resin system through the injection adaptor and into the drilled hole so that the static mixer of the injection adaptor mixes the multi-part resin system so that the cured resin secures the cable bolt in the drilled hole.

According to the invention there is also provided a secured tunnel in a ground formation whereby the tunnel is secured by one or more cable bolts which are each secured by a cured multi-part resin system.

Advantages of the invention include that the use of the injection adaptor with a resin ensures that the resin is mixed well, giving confidence that the bolt was installed properly. Pumpable, multi-component resins for anchoring rock bolts provide significant advantages over traditional cartridge resin and cement grout systems where fast and easily adaptable support is required for challenging ground conditions. This is because multi-component resins are generally faster curing than cement systems. Using the injection adaptor according to the invention, the resin is pre-mixed before it is injected into the drilled hole and so the resin is already thickening and beginning to cure as it is being injected. As a result, it is not necessary to block the drilled hole with stemming material as the thickened resin will not escape from the drilled hole, even when the hole is in the roof of a tunnel. As no stemming material is required, no breather tube is needed either, simplifying the installation procedure compared to cable bolting with a cement grout. Generally, known multi-part resin systems will cure in less than an hour, allowing plating and tensioning of the cable bolts much more rapidly after their installation. This rapid installation process allows for the rock face to be advanced much more quickly after installation. The rapid installation allows the work on the ground formation to be continued immediately, without damage or negative effects to the grouted bolts. The cycle time saving is a minimum of 24 hours, which is the typical minimum wait for non shrink cement grouts.

In some embodiments, the multi-part resin system is a two part resin system wherein a first part of the resin system comprises an isocyanate and a second part of the resin system comprises a silicate. Advantages of using a two part resin system comprising an isocyanate pre-polymer and a silicate include that it has an early cure strength sufficient to retain a rock anchor in a drilled hole without additional support. It also has a high flash point, low flammability and a high oxygen index. Also, the supply pipes and pump used for the second part of the resin system may be cleaned using water as silicate is water soluble. Such a resin system is very fast curing as it sets in less than one minute after pumping and allows plating and tensioning of the cables in less than ten minutes after installation of the cable bolt.

In some embodiments, the two part resin system may be the two component silicate resin system sold by Minova Australia Pty Ltd under the trade mark “CARBOTHIX”. Advantages of using Carbothix® include that:
it is in a volume ratio of one part silicate to two parts isocyanate pre polymer which makes pumping and maintaining the ratio easier (but may be used at alternative volume ratios between 1:1 and 1:3);
it does not include a particulate filler such that there are no particles to jam in a pump or other pathways used to inject the resin system;
it has a low viscosity (approximately 200-400 cps) such that it is easy to pump;
elimination of cold storage of polyester resin to extend shelf life;
variable injection quantity to ensure full encapsulation of rock bolt;
testing for isocyanates indicated that they were non-detectable or significantly below the minimum threshold limits.

In some embodiments, the volume ratio of the components of the multi-part resin system may be selected so that the resin does not fully cure in less time than is required to pump the resin system into the drilled hole. As the volume ratio can be selected by the operator of the pumps for the multi-part resin system, it is straight forward for a skilled person to determine a suitable ratio as the skilled person would be aware that the setting time was too long if when the hole was filled, the resin was not sufficiently thickened. Also a skilled person would be aware if the setting time was too short if the resin had cured in the drilled hole before the drilled hole had been filled with the resin. The choice of the ratio would depend on factors such as the size of the drilled hole due to friability of the ground formation or the presence of fractures or other faults, the ambient temperature, pressure or humidity, and/or the type of ground formation.

In some embodiments, the static mixer has at least 10 elements. For example, the static mixer may have from 10 to 48 elements; particularly about 30 elements. Where the resin system is Carbothix®, such a large number of elements is required to provide high energy mixing. Incomplete mixing of Carbothix® can easily be detected because the resin foams on curing.

In some embodiments, the cable bolt may be further secured by a mesh netting. In some embodiments, the cable bolt may have any features that are conventional in cable bolt technology and may have any length typical in the cable bolting field. The term “ground formation” refers to a mass of rock, earth and/or soil such as may be found in an embankment, quarry, mine or tunnel.

The invention will now be illustrated with reference to the following Figures of the accompanying drawings which are provided to illustrate the invention claimed and are not intended to limit the scope of protection:

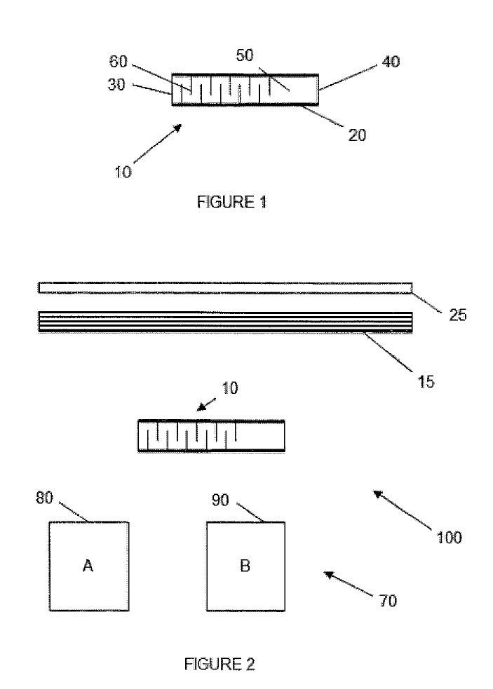

FIG. 1 shows a schematic view of an injection adaptor according to the invention;

FIG. 2 shows a schematic view of a kit according to the invention;

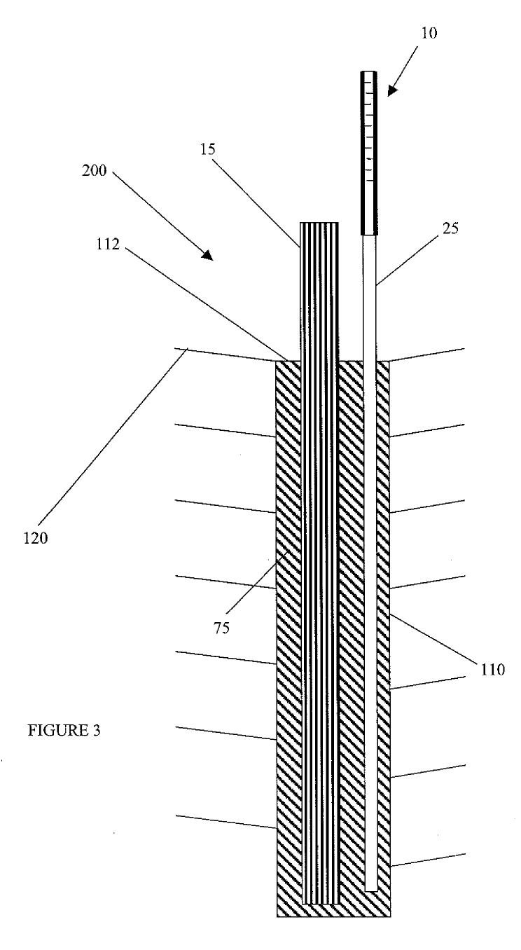

FIG. 3 shows a schematic view of a secured cable bolt according to the invention; and

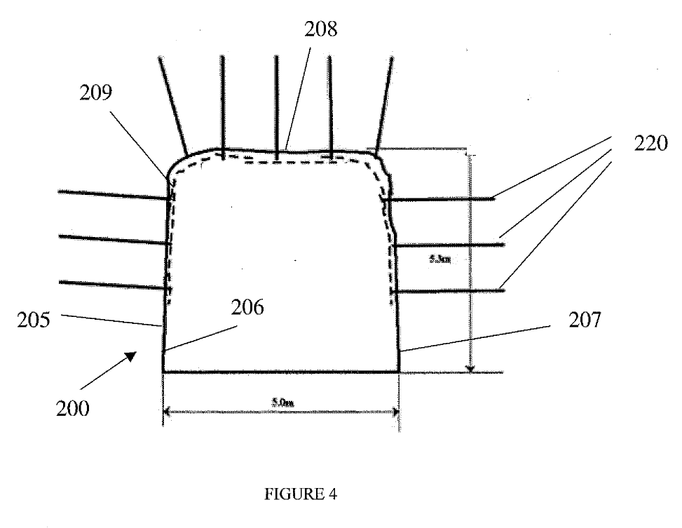

FIG. 4 shows an alternative embodiment of a secured rock anchor according to the invention.

FIG. 1 shows an injection adaptor 10 according to the invention. The adaptor is in the form of a tube having a body 20 which has an input port 30, a static mixer 60 placed in the body 20 of the tube near the input port 30, an internal passage 50 and an output port 40. The input port 30 is generally arranged at an end of the injection adaptor 10 and is adapted to connect to a multi-component-resin pump. The output port 40 is generally arranged at an end of the injection adaptor 10 and is adapted to connect to an injection tube. The injection adaptor 10 is generally less than about 1 metre long; typically it is from 40 cm to 60 cm long, for example about 45 cm long.

FIG. 2 shows a kit 100 according to the invention. The kit 100 comprises an injection adaptor 10 as illustrated in FIG. 1, a cable bolt 15, an injection tube 25 and a two part resin system indicated generally at 70. The two part resin system 70 contains a first isocyanate part 80 and a second silicate part 90. The cable bolt 15 is from 3 m to 10 m long, for example 5 m long. The injection tube 25 is typically from 2 m to 5 m long, for example about 3 m long.

FIG. 3 shows a secured rock anchor 200 according to the invention. FIG. 3 shows a ground formation 120 in the form of a rock wall. A drilled hole 110 is shown in the rock wall 120 in which cable bolt 15 has been secured by cured multi-part resin system 75. The multi-part resin system 75 has been pumped into the drilled hole 110 through injection adaptor indicated generally at 10 and injection tube 25.

The method for securing a cable bolt 15 in a ground formation 120 comprises the following steps. After the ground formation has been prepared, for example by excavating the tunnel, a hole is drilled in the ground formation to form a drilled hole 110. The drilled hole 110 has a proximal end 112 which is at the hole opening and a distal end 114. The cable bolt 15 is then inserted into the drilled hole 110 with injection tube 25. Injection adaptor 10 is then connected to the injection tube 25 and the multi-part resin pump may be connected to the injection adaptor 10 before or after that connection is made. Then the multi-part resin system 75 is pumped through injection adaptor 10 so that the static mixer 60 in the injection adaptor 10 causes intimate mixing of the parts of the resin system. As the resin system begins to thicken, the resin system is pumped through the injection tube to fill the drilled hole 110 from its distal end. The multi-part resin system 75 then cures to secure the cable bolt 15 in place to stabilise the ground formation 120.

In an alternative embodiment the cable bolt may have a mechanical shell to allow pre-tensioning of the cable bolt 15 before injection of the resin system for encapsulation of the cable bolt 15.

FIG. 4 shows a secured mine tunnel 200. The mine tunnel has a width of 5.0 m and a height of 5.3 m. It is in a ground formation 205 which has been secured on each of the vertical walls 206,207 by three rock anchors 220. The roof 208 has been secured by five cable bolts 220. A metal wire mesh netting 209 has been provided to further secure the mine tunnel 200.

### EXAMPLE 1

Evaluative testing of the method and kit according to the invention was conducted as a dynamic support system for worsening ground conditions including strain bursting.

The tests were carried out, in the high grade copper veins where drilling in the soft and friable ore can create significant hole over-sizing.

Cable bolts were installed in challenging locations in the copper mine by the method of the invention. A fast set Minova Carbothix® resin with a 1:1 ratio of silicate to isocyanate and a set time of about 1 minute was used with a 5 m cable bolt. In some areas, where the drilled hole intersected stress fracturing or migrated along structural features, there were issues with holes not being filled completely before pump pressures increased significantly, indicating that the resin had cured. This was a limited occurrence with trained operators but a solution was required. In such areas, a Minova Carbothix® resin was used having a set time of 3-4 minutes.

### COMPARATIVE EXAMPLE 2

As a comparison, cable bolts were installed by the known method of cement grouting in a similar location to Example 1.

Double 16 mm steel cable bolts were used in 3-10 metre deep holes for long support. Before the cable bolt was inserted into the drilled hole, a plastic breather tube was taped to the cable bolt so that the tube reached the distal end of the drilled hole. The cable bolt and breather tube were pushed into the hole and a large diameter cement grout tube was installed about 0.6 m into the hole. The entire opening around the cable bolt, grout tube and breather tube was then packed with stemming materials and spray foam to prevent the cement from running out of the hole. The hole was then pumped with cement from the hole opening. When the cement reached the end of the hole, it was forced back down the breather tube. Once the cement was detected at the proximal end of the breather tube, the cement pump was stopped. A period of 24 hours minimum was required for the cement to cure before the cable bolt could be plated and tensioned to approximately 10 tons.

It can therefore be seen that the known method is much more complicated than the method of the invention and is more time consuming. Using the resin injection adaptor according to the invention eliminates the need for breather tubes (as the drilled hole is filled from the back to the front). There is no need to stem the drilled hole opening as the resin is thixotropic and will not spill out of even vertical holes. The resin is delivered in a consistent volume ratio from the pump, fills voids, consolidates fractured ground and cures immediately to allow plating and tensioning in 10 minutes.

### EXAMPLE 3

In tests, it has been found that where the two part resin system 70 is Carbothix®, the punch shear is 75% greater after 6 minutes than that obtained by using a non-pumpable polyester resin version. After 10 minutes, the punch shear is 100% greater. Carbothix® was found to have a mean maximum exothermic temperature on mixing of 97° C. over a curing time of about 4 minutes, meeting the requirements of MDG 3006 MRT8 (Draft, January 2007) Section 5.1 a) for maximum exothermic temperature. It was also found to meet the MDG 3006 MRT 8 (Draft, January 2007) Section 5.1 b), c), d), e) and f) requirements for electrical resistance, fire resistance (after being exposed to a burner flame for 60 seconds, the persistence of a flame on a sample of Carbothix was at most 2 seconds showing a low flammability), fire propagation, flash point (in tests, it was not possible to determine the flash point as it was above 100° C.) and chemical characterisation of resin components, respectively.

It was found that the Minova resin injection system ensures complete bolt encapsulation, eliminating questions of whether resin cartridges were mixed properly allowing the bolt to set as per design.

### EXAMPLE 4

The properties of a two part resin system 70 using Carbothix® were compared with those for Minova Australia Pty Ltd product, Geoflex®. The results obtained are shown in Table 1 below from which it can be seen that Carbothix® exhibited greater punch shear and flexural strength at all times post curing.

TABLE 1

| | | | | Punch | | Punch | | Punch |
|---|---|---|---|---|---|---|---|---|
| | | Gel | Flexural | Shears | Flexural | Shears | Flexural | shears |
| | Ratio | time | 15 min | 15 Min | 1 hour | 1 hour | 24 hours | 24 hrs |
| Geoflex | 1:1 | 85″ | 0.6 MPa | 9.50 MPa | 3 MPa | 13.6 MPa | 9.25 MPa | 17.65 MPa |
| Carbothix | 1:2 | 55″ | 4.52 MPa | 24.52 MPa | 13.6 MPa | 26.12 MPa | 16.23 MPa | 29.93 MPa |

What is claimed is:

1. An injection adaptor suitable for injecting a multi-component resin into a ground formation wherein the adapter comprises a resin component input port, a static mixer and a mixed resin output port.

2. The adaptor as defined in claim 1 wherein the static mixer has at least 10 elements.

3. A system comprising a cable bolt, an injection adaptor suitable for injecting a multi-component resin into a ground formation wherein the adapter comprises a resin component input port, a static mixer and a mixed resin output port, and a multi-part resin system.

4. The system as defined in claim 3 wherein the multi-part resin system is a two part resin system wherein a first part of the resin system comprises an isocyanate and a second part of the resin system comprises a silicate.

5. The system as defined in claim 4 wherein the two part resin system is CARBOTHIX.

6. A method of securing a cable bolt in a hole drilled in a ground formation which method comprises the steps of:
providing a cable bolt, an injection tube, and an injection adaptor suitable for injecting a multi-component resin into a ground formation wherein the adapter comprises a resin component input port, a static mixer and a mixed resin output port;
inserting the cable bolt and the injection tube into the drilled hole such that an end of the injection tube is arranged at or near the distal end of the drilled hole;
connecting the injection adaptor to the injection tube; and
pumping a multi-part resin system through the injection adaptor and into the drilled hole so that the static mixer of the injection adaptor mixes the multi-part resin system so that the cured resin secures the cable bolt in the drilled hole.

7. The method as defined in claim 6 wherein the multi-part resin system is a two part resin system wherein a first part of the resin system comprises an isocyanate and a second part of the resin system comprises a silicate.

8. The method as defined in claim 6 wherein the two part resin system is CARBOTHIX.

9. The method as defined in claim 6 which further comprises the step of securing the cable bolt with a mesh netting.

10. The method as defined in claim 6 wherein the term ground formation is a mass of rock, earth and/or soil such as may be found in an embankment, quarry, mine or tunnel.

11. The cable bolt secured in a ground formation by a multi-part resin system.

12. The cable bolt as defined in claim 11 which is secured by a method comprising the steps of:
providing a cable bolt, an injection tube, and an injection adaptor suitable for injecting a multi-component resin into a ground formation wherein the adapter comprises a resin component input port, a static mixer and a mixed resin output port;
inserting the cable bolt and the injection tube into the drilled hole such that an end of the injection tube is arranged at or near the distal end of the drilled hole;
connecting the injection adaptor to the injection tube; and
pumping a multi-part resin system through the injection adaptor and into the drilled hole so that the static mixer of the injection adaptor mixes the multi-part resin system so that the cured resin secures the cable bolt in the drilled hole.

13. A secured tunnel in a ground formation whereby the tunnel is secured by one or more cable bolts which are each secured by a cured multi-part resin system.

14. The secured tunnel as defined in claim 13 which is secured by cable bolts which are secured by a method comprising the steps of:
providing a cable bolt, an injection tube, and an injection adaptor suitable for injecting a multi-component resin into a ground formation wherein the adapter comprises a resin component input port, a static mixer and a mixed resin output port;
inserting the cable bolt and the injection tube into the drilled hole such that an end of the injection tube is arranged at or near the distal end of the drilled hole;
connecting the injection adaptor to the injection tube; and
pumping a multi-part resin system through the injection adaptor and into the drilled hole so that the static mixer of the injection adaptor mixes the multi-part resin system so that the cured resin secures the cable bolt in the drilled hole.
